(19) United States
(12) Patent Application Publication
(10) Pub. No.: US 2009/0128690 A1
(43) Pub. Date: May 21, 2009

(54) SYSTEMS AND METHODS FOR USE IN TRANSFORMING ELECTRONIC INFORMATION INTO A FORMAT

(75) Inventors: Ian Shaw Burnett, Victoria (AU); Joseph Alfred Ian Thomas-Kerr, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: Enikos Pty Limited, Sydney (AU)

(21) Appl. No.: 11/995,102

(22) PCT Filed: Jul. 10, 2006
(86) PCT No.: PCT/AU06/00969

§ 371 Date: Dec. 22, 2008

(30) Foreign Application Priority Data
Jul. 8, 2005 (AU) 2005903645

(51) Int. Cl. H04N 11/02

(52) U.S. Cl. 348/426.1; 348/E11.006

(57) ABSTRACT

A method for transforming electronic information in to a format, the method comprising the steps of: accessing a first electronic file that comprises control data; accessing metadata based on the control data; identifying input data based on the metadata and the control data; and creating output data that is based on the input data and which has an output format that is based on the control data.

### FIELD OF THE INVENTION

The present invention relates generally to the field of transforming electronic information in to a format, and has particular—but by no means exclusive—application to the MPEG-21 multimedia frame work.

### BACKGROUND OF THE INVENTION

There is an enormous amount of electronic content available today. For instance, it is possible to obtain from the Internet a multitude of multimedia content including video and audio clips. Much of today's electronic content is made available in a particular format. For example, music is typically made available in the MP3 format while video clips are generally available as MPEG clips.

Due to the heterogenous nature of the technology used to create, distribute and play electronic content it is highly desirable to have in place tools that enable people to make electronic content available in a suitable format. As an example, the MPEG video clip format may be suitable for distributing electronic content to users over broadband Internet links. However, sending a video clip in an MPEG format over a wireless link may not be suitable because the MPEG format may consume an undesirable amount of the bandwidth of the wireless link. In the case of sending a video clip over a wireless link it would therefore be desirable to convert the MPEG video clip in to some other format more suitable for transferring of the wireless link.

### SUMMARY OF THE INVENTION

According to a first aspect of the present invention there is provided a method for transforming electronic information in to a format, the method comprising the steps of:

accessing a first electronic file that comprises control data;

accessing metadata based on the control data;

identifying input data based on the metadata and the control data; and

creating output data that is based on the input data and which has an output format that is based on the control data.

An advantage of the present invention is that it provides a generic framework for readily transforming electronic information (input data) from one format to another format. The advantage stems from the fact that the present invention accesses the metadata, which basically describes the format of the electronic information (which may for example be a multimedia file). The present invention uses the metadata to access the electronic information. By reading (accessing) the control data the present invention is able to determine the required output format in to which the electronic information is to be transformed.

Preferably, the output format is one of a plurality of output formats comprising:

a first MPEG-21 digital item; and

a second user defined format that is described in a second electronic file.

Being able to arrange the output data in to the MPEG-21 digital item means that the present invention can be used to readily used to convert existing digital content (such as an MP3 with an embedded ID3 tag) in to an MPEG-21 compliant digital item. An advantage of being able to convert the electronic information (input data) in to the second user defined format is that the present invention allows, for example, an MP3 file of a particular bit rate to be converted in to a lower bit rate.

Preferably, the step of creating the output data comprises at least one of the following steps:

saving the output data in a third electronic file; and

effecting a transfer of the output as a first bit-stream.

Being able to save the output data in the third electronic file enables the output data to be distributed by way of, for example, a CD-ROM or a DVD disc. On the other hand, being able to transfer the output as a first bit-stream provides an advantage of being able to readily distribute the output data via, for example, the Internet.

Preferably, the input data is a fragment of another piece of input data.

Having the input data as a fragment of another piece of input data is advantageous because it enables only required data to be extracted from the piece of input data.

Preferably, the control data accords with a bit-stream binding language.

An advantage of having the control data accord with the MPEG-21 bit-stream binding language is that it enables the present invention to be readily used to produce output data from an MPEG-21 digital item.

Preferably, the metadata accords with an extensible mark-up language.

Using the extensible mark-up language enables the structure (format) of the input data to be readily described.

Preferably, the input data has one of a plurality of input formats comprising:

a second MPEG-21 digital item;

a second user defined format that is described in a fourth electronic file; and

a second bit-stream.

Use of the second MPEG-21 digital item is advantageous because it allow the present invention to be used to transform MPEG-21 digital items. On the other hand, the second user defined format means that the present invention is not limited to being used to transform MPEG-21 digital items. Describing the format in the fourth electronic file means that the present invention has application to transforming a range of different data and not just MPEG-21 digital items. Being able to handle the second bit-stream allows the present invention to readily transform data that is received via, for example, the Internet.

According to a second aspect of the present invention there is provided a method of facilitating a transformation of electronic information in to a format, the method comprising the step of creating an electronic file that comprises control data that enables a process to: access metadata based on the control data; identify input data based on the metadata and the control data; and creating output data that is based on the input data and which has an output format that is based on the control data.

Preferably, the output format is one of a plurality of output formats comprising:

a first MPEG-21 digital item; and

a second user defined format that is described in a second electronic file.

Preferably, the process is arranged to create the output data by performing at least one of the following steps:

saving the output data in a third electronic file; and

effecting a transfer of the output as a first bit-stream.

Preferably, the input data is a fragment of another piece of input data.

Preferably, the control data accords with a bit-stream binding language.

Preferably, the metadata accords with an extensible mark-up language.

Preferably, the input data has one of a plurality of input formats comprising:

a second MPEG-21 digital item;

a second user defined format that is described in a fourth electronic file; and

a second bit-stream.

According to a third aspect of the present invention there is provided a device for transforming electronic information in to a format, the device comprising a processing means arranged to perform the steps of:

accessing a first electronic file that comprises control data;

accessing metadata based on the control data;

identifying input data based on the metadata and the control data; and

creating output data that is based on the input data and which has an output format that is based on the control data.

Preferably, the output format is one of a plurality of output formats comprising:

a first MPEG-21 digital item; and

a second user defined format that is described in a second electronic file.

Preferably, the processing means is arranged such that the step of creating the output data comprises at least one of the following steps:

saving the output data in a third electronic file; and

effecting a transfer of the output as a first bit-stream.

Preferably, the input data is a fragment of another piece of input data.

Preferably, the control data accords with a bit-stream binding language.

Preferably, the metadata accords with an extensible mark-up language.

Preferably, the input data has one of a plurality of input formats comprising:

a second MPEG-21 digital item;

a second user defined format that is described in a fourth electronic file; and

a second bit-stream.

According to a fourth aspect of the present invention there is provided a device for facilitating a transformation of electronic information in to a format, the device comprising a processing means arranged to perform the step of creating an electronic file that comprises control data that enables a process to: access metadata based on the control data; identify input data based on the metadata and the control data; and creating output data that is based on the input data and which has an output format that is based on the control data.

Preferably, the output format is one of a plurality of output formats comprising:

a first MPEG-21 digital item; and

a second user defined format that is described in a second electronic file.

Preferably, the process is arranged to create the output data by performing at least one of the following steps:

saving the output data in a third electronic file; and

effecting a transfer of the output as a first bit-stream.

Preferably, the input data is a fragment of another piece of input data.

Preferably, the control data accords with a bit-stream binding language.

Preferably, the metadata accords with an extensible mark-up language.

Preferably, the input data has one of a plurality of input formats comprising:

a second MPEG-21 digital item;

a second user defined format that is described in a fourth electronic file; and

a second bit-stream.

According to a fifth aspect of the present invention there is provided a computer program comprising at least one instruction, which when executed by a computing device causes the computing device to perform the method according to the first aspect of the present invention and/or the second aspect of the present invention.

According to a sixth aspect of the present invention there is provided a computer readable medium comprising the computer program according to the fifth aspect of the present invention.

### BRIEF DESCRIPTION OF THE DRAWINGS

The present invention will be more fully understood from the following description of an embodiment with reference to the following drawings, in which:

FIG. 1 is a schematic diagram of a system in accordance with an embodiment of the present invention;

FIG. 2 is a flow chart of various steps performed by the system of FIG. 1;

FIG. 3 is an example of control data used by the system of FIG. 1; and

FIG. 4 provides an illustration of a relationship between data and the system of FIG. 1.

### AN EMBODIMENT OF THE INVENTION

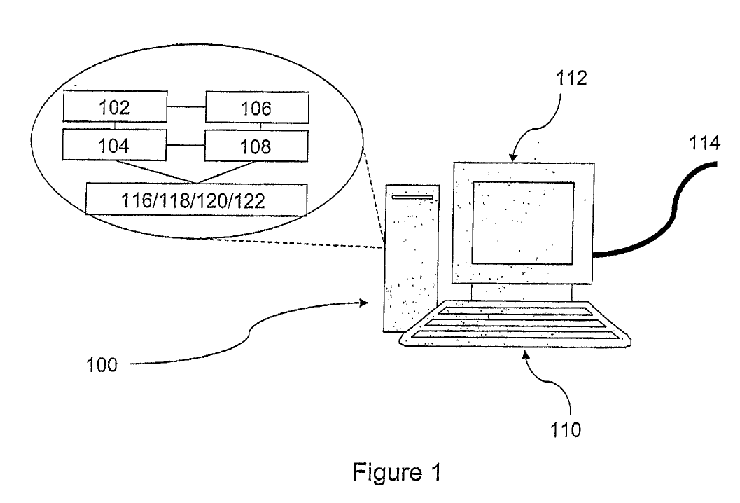

At FIG. 1 there is shown a schematic diagram of a computing system 100 suitable for use with an embodiment of the present invention. The computing system 100 may be used to execute applications and/or system services such as a tournament structure in accordance with an embodiment of the present invention. The computing system 100 preferably comprises a processor 102, read only memory (ROM) 104, random access memory (RAM) 106, and input/output devices such as disk drives 108, input peripherals such as a keyboard 110 and a display (or other output device) 112. The computer includes software applications that may be stored in RAM 106, ROM 104, or disk drives 108 and may be executed by the processor 102.

A communications link 114 connects to a computer network such as the Internet. However, the communications link 114 could be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive 108 or multiple disk drives. The computing system 100 may use any suitable operating systems 116, such as Microsoft Windows™ or a Unix™ based operating system.

The system further comprises a software application 118 which in the present embodiment is a software application capable of converting input data from one format to another format. The software application 118 may interface with other software applications 120 or with a remote computer (not shown) via communications link 114. In the present embodiment, the input data is multimedia related data such as, for example, an MPEG-21 digital item or an MP3 binary bit stream.

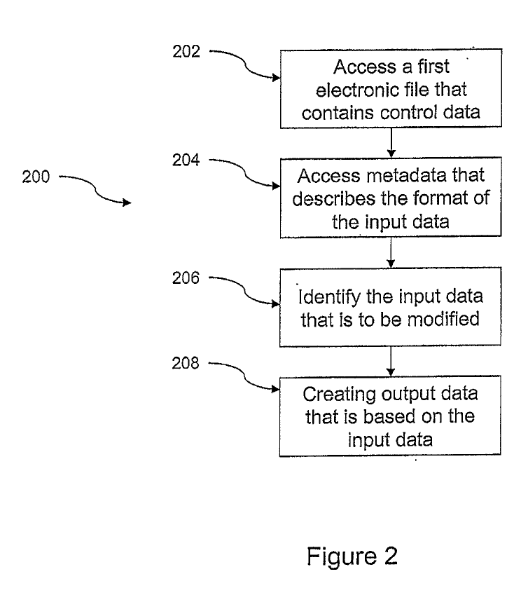

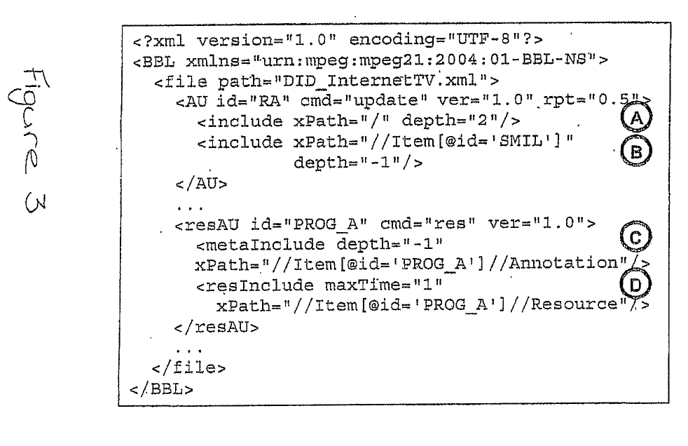

The binary bit stream processing application performs various steps when converting the input data from one format to another format. The steps performed by the binary bit stream processing application are shown in the flow chart 200 of FIG. 2 In this regard, the first step 202 performed by the binary bit stream processing application is to access (or read) a first electronic file that contains control data. The first electronic file is in the form of a .bbl file (or binary bit-stream language file), while the control data contained in the first electronic file are various language statements from the binary bit-stream language. The control data contained in the first electronic file allows the binary bit stream processing application to determine what actions need to be performed when converting the input data from one format to another format. FIG. 3 provides an example of the control data (binary bit-stream language statements) that may be contained in the first electronic file. The reader is referred to Appendix A of this specification for a complete description of the binary bit-stream language.

The first electronic file, and the control data contained therein, may be created by a person wanting to convert the input data from one format to another format. In this regard, the hard disk of the system 100 may be loaded with a user application that enables a person to readily create the first electronic file.

Subsequent to performing the previous step 202, the binary bit stream processing application performs the step 204 of accessing metadata that describes the format of the input data. To gain access to the metadata the binary bit stream processing application examines the control data (in the first electronic file), which enables the binary bit stream processing application to access (read) an electronic file containing the metadata. The electronic file is a .xml file and as such the metadata is in the form of various extensible mark-up language (XML) statements. With reference to FIG. 3, the control data that enables the binary bit stream processing application to locate the .xml file is the <file path=“DID_InternetTV.xml”> statement.

Once the binary bit stream processing application has performed the step 204 it proceeds to carry out the step 206 of identifying the actual input data that is to be converted. To identify the actual input data the binary bit stream processing application initially examines the control data (contained in the first electronic file) for a reference to the input data. In relation to FIG. 3, the reference includes the various xPath statements such as, for example, xPath=“//Item[@id=‘PROG_A] . . . ”. After obtaining the reference, the binary bit stream processing application resolves the reference using the metadata to identify the actual input data. It is noted that the control data shown in FIG. 3 contain several references, which in effect cause the binary bit stream processing application to identify multiple pieces of input data which form fragments of a larger piece of electronic content data.

Subsequent to carrying out the step 206 of identifying the input data, the binary bit stream processing application performs the step 208 of creating output data that is based on the input data and which has an output format that is based on the control data. In summary, the step 208 of creating the output data is the actual process of converting the input data from one format to another format. More specifically, the step 208 involves examining the control data (which is contained in the first electronic file) to determine the required data format for the output data. The binary bit stream processing application is capable of producing the output data in a range of data formats including, for example, an MPEG-21 digital item, a user defined format that is described in an electronic file containing extensible mark-up language description of the user defined format.

As an example of how the control data (which are binary bit stream language statement) describe the required format for the output data, the reader is referred to section 3.2.6.10 of the document included in Appendix A of this specification. Section 3.2.6.10 describes the binary bit-stream language statement of <encoder> which enables the binary bit stream processing application to determine the required format for the output data. The <encoder> statement can be used to inform the binary bit stream processing application that it is to perform formatting operations such as, for example, TeM, BiM, encryption or transcoding on the input data identified during the previous step 206. In relation to the transcoding, the binary bit stream processing application can, for example, convert the input data from one bit rate to another bit rate. In order to perform the formatting operations, the binary bit stream processing application invokes an appropriate process. In the case where the input data is to be encrypted the binary bit stream processing application would invoke a suitable encryption process.

As part of the step 208 of creating the output data the binary bit stream processing application is arranged to save the output data in an electronic file and/or effect the transfer of the output data as a bit-stream. Saving the output data in an electronic file enables the output data to be readily distributed on, for example, CD-ROM and/or DVD. In relation to transferring the output data as a bit-stream, this enables the output data to be readily distributed via, for example, the Internet. When effecting a transfer of the output data as a bit-stream the binary bit stream processing application is arranged to place the output data in to access units, which can essentially considered data packets of the output data. The access unit are then transferred via a network using an appropriate transport protocol such as the Real-time Transport Protocol (RTP).

The binary bit stream processing application is arranged such that when placing the output data in to the access units it is capable of representing the access units in a textual format or a binarised format. While the textual format is suitable for a number of scenarios, it can be rather verbose. By representing the access units in the binarised format it is possible to achieve up to 90% to 95% reduction in the bit rate required when representing the access unit in the textual format.

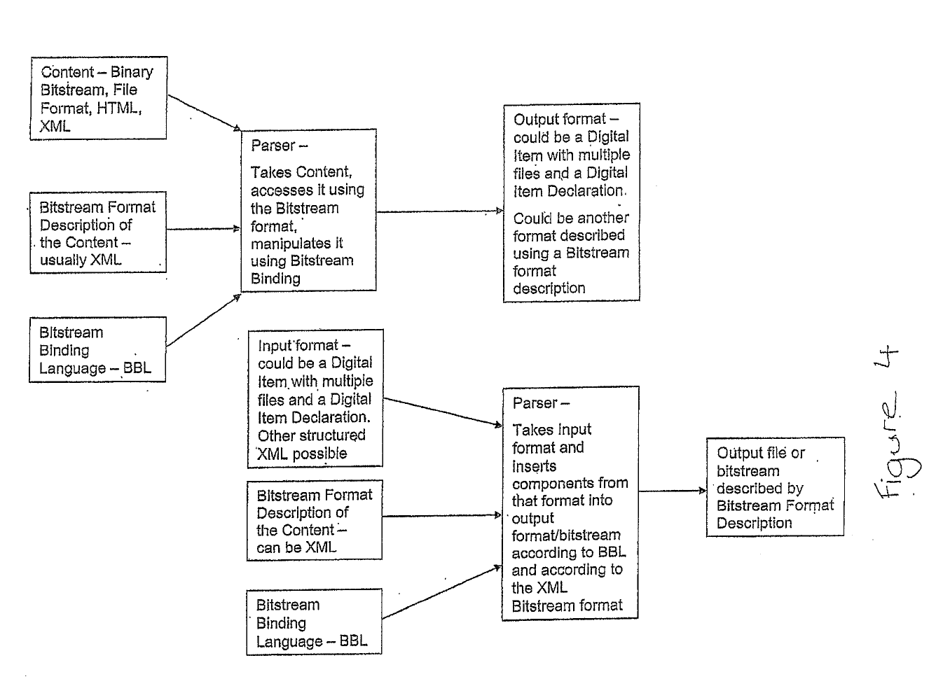

FIG. 4 illustrates the relationship between the binary bit stream processing application and the input data, metadata, control data and the output data.

1. The fragment identification is universal as BBL depends on either:
(a) Structured XML according to an XML schema;
(b) A binary format which is described using a Binary Structure Format Tool (e.g. BSDL or XFlavor). This means that regardless of the content being XML or binary in its original form, the fragments that are extracted may be identified and located in an identical fashion.

2. The Fragment scheme above can also be used to allow the output format to be ‘identically’ accessed using XML tools (such as XPATH). Alternatively binding to the output format can be direct through a ‘handler’. The choice depends on where the boundary between ‘procedural’ and ‘declarative’ approaches to format handling is drawn. Within the framework the boundary can be arbitrarily moved back and forward and set at the appropriate level for an application.

3. Output fragments can be encoded/transcoded/transformed using an ‘encoder’ to an appropriate format. Hence, an MP3 file in the original content could be transcoded on a fragment by fragment basis to AAC and hence be bound into the output stream as AAC fragments. Similarly, fragments of XML metadata in MPEG-7 in the original content could be encoded using a binary encoder to BiM (binary metadata) or encrypted before insertion into the output stream/format.

4. The language BBL can specify a large set of content/metadata from an input package and then create output fragments of that set of content/metadata on the basis of declared fragmentation rules. Examples of the rules are: certain structural elements appear at the start/end of a fragment, certain structural elements are non-divisible, output fragments are of a maximum size or temporal duration.

5. When a fragment identification is supplied, the BBL automatically deals with the nature of the content identified i.e. if the identifier points to a binary content the BBL will access the appropriate BSFT description to access the content and hence resolve the fragment identification. Alternatively if the identifier points to an XML file, standard XML access on the basis of e.g. an XPATH will be performed.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### BIBLIOGRAPHY

[1] Meer, J. v. d., et al., RFC3640: RTP Payload Format for Transport of MPEG-4 Elementary Streams. 2003.
[2] W3C, XSL Transformations (XSLT), W3C Recommendation. 16 Nov. 1999.
[3] W3C XPATH2.0, XML Path Language (XPath) 2.0, W3C Candidate Recommendation, 3 Nov. 2005.

1. A method for transforming electronic information in to a format, the method comprising the steps of:
accessing a first electronic file that comprises control data;
accessing metadata based on the control data;
identifying input data based on the metadata and the control data; and
creating output data that is based on the input data and which has an output format that is based on the control data.

2. The method as claimed in claim 1, wherein the output format is one of a plurality of output formats comprising:
a first MPEG-21 digital item; and
a second user defined format that is described in a second electronic file.

3. The method as claimed in claim 1, wherein the step of creating the output data comprises at least one of the following steps:
saving the output data in a third electronic file; and
effecting a transfer of the output as a first bit-stream.

4. The method as claimed in claim 1, wherein the input data is a fragment of another piece of input data.

5. The method as claimed in claim 1, wherein the control data accords with a bit-stream binding language.

6. The method as claimed in claim 1, wherein the metadata accords with an extensible mark-up language.

7. The method as claimed in claim 1, wherein the input data has one of a plurality of input formats comprising:
a second MPEG-21 digital item;
a second user defined format that is described in a fourth electronic file; and
a second bit-stream.

8. A method of facilitating a transformation of electronic information in to a format, the method comprising the step of creating an electronic file that comprises control data that enables a process to: access metadata based on the control data; identify input data based on the metadata and the control data; and creating output data that is based on the input data and which has an output format that is based on the control data.

9. The method as claimed in claim 8, wherein the output format is one of a plurality of output formats comprising:
a first MPEG-21 digital item; and
a second user defined format that is described in a second electronic file.

10. The method as claimed in claim 8, wherein the process is arranged to create the output data by performing at least one of the following steps;
saving the output data in a third electronic file; and
effecting a transfer of the output as a first bit-stream.

11. The method as claimed in claim 8, wherein the input data is a fragment of another piece of input data.

12. The method as claimed in claim 8, wherein the control data accords with a bit-stream binding language.

13. The method as claimed in claim 8, wherein the metadata accords with an extensible mark-up language.

14. The method as claimed in claim 8, wherein the input data has one of a plurality of input formats comprising:
a second MPEG-21 digital item;
a second user defined format that is described in a fourth electronic file; and
a second bit-stream.

15. A device for transforming electronic information in to a format, the device comprising a processing means arranged to perform the steps of:
accessing a first electronic file that comprises control data;
accessing metadata based on the control data;
identifying input data based on the metadata and the control data; and
creating output data that is based on the input data and which has an output format that is based on the control data.

16. The device as claimed in claim 15, wherein the output format is one of a plurality of output formats comprising:
a first MPEG-21 digital item; and
a second user defined format that is described in a second electronic file.

17. The devices as claimed in claim 15, wherein the process means is arranged such that the step of creating the output data comprises at least one of the following steps:
saving the output data in a third electronic file; and
effecting a transfer of the output as a first bit-stream.

18. The device as claimed in claim 15, wherein the input data is a fragment of another piece of input data.

19. The device as claimed in claim 15, wherein the control data accords with a bit-stream binding language.

20. The device as claimed in claim 15, wherein the metadata accords with an extensible mark-up language.

21. The device as claimed in claim 15, wherein the input data has one of a plurality of input formats comprising:
a second MPEG-21 digital item;
a second user defined format that is described in a fourth electronic file; and
a second bit-stream.

22. A device for facilitating a transformation of electronic information in to a format, the device comprising a processing means arranged to perform the step of creating an electronic file that comprises control data that enables a process to: access metadata based on the control data; identify input data based on the metadata and the control data; and creating output data that is based on the input data and which has an output format that is based on the control data.

23. The device as claimed in claim 22, wherein the output format is one of a plurality of output formats comprising:
a first MPEG-21 digital item; and a second user defined format that is described in a second electronic file.

24. The device as claimed in claim 22, wherein the process is arranged to create the output data by performing at least one of the following steps:
saving the output data in a third electronic file; and
effecting a transfer of the output as a first bit-stream.

25. The device as claimed in claim 22, wherein the input data is a fragment of another piece of input data.

26. The device as claimed in claim 22, wherein the control data accords with a bit-stream binding language.

27. The device as claimed in claim 22, wherein the metadata accords with an extensible mark-up language.

28. The device as claimed in claim 22, wherein the input data has one of a plurality of input formats comprising:
a second MPEG-21 digital item;
a second user defined format that is described in a fourth electronic file; and
a second bit-stream.

29. A computer program comprising at least one instruction, which when executed by a computing device causes the computing device to perform the method as claimed in claim 1.

30. A computer readable medium comprising the computer program as claimed in claim 29.
